(19) United States
(12) Patent Application Publication
(10) Pub. No.: US 2004/0118205 A1
(43) Pub. Date: Jun. 24, 2004

(54) Vibratory gyroscopic rate sensor

(76) Inventors: Christopher P Fell, Plymouth (GB); Rebecka Eley, Plymouth (GB); Colin H J Fox, Nottingham (GB)

Correspondence Address: NIXON & VANDERHYE, PC, 1100 N GLEBE ROAD, 8TH FLOOR, ARLINGTON, VA, 22201-4714, US

(21) Appl. No.: 10/475,014

(22) PCT Filed: Sep. 6, 2002
(86) PCT No.: PCT/GB02/04051

(30) Foreign Application Priority Data
Sep. 14, 2001 (GB) 0122258.7

(51) Int. Cl. G01C 9/04

(52) U.S. Cl. 73/504.13

(57) ABSTRACT

A single axis rate sensor including a substantially planar vibratory resonator (1) having a substantially ring or hoop-like structure with inner and outer peripheries (1a, 1b) extending around a common axis (z) drive means (6) for causing the resonator (1) to vibrate in a Cos 2θ vibration mode, carrier mode pick-off means (7) for sensing movement of the resonator (1) in response to said drive means pick-off means (9) for detecting Sin 2θ vibration mode motion induced by rotation around the Z-axis, Sin 2θ vibration mode drive means (8) for nulling said motion and support means (2) for flexibly supporting the resonator (1) and for allowing the resonator (1) to vibrate relative to the support means (2) in response to the drive means, or to applied rotation wherein the support means comprises only L support beams, where L≠2^{K}, and K=0, 1,2 or 3.

This invention relates to rate sensors for sensing applied rate on one axis.

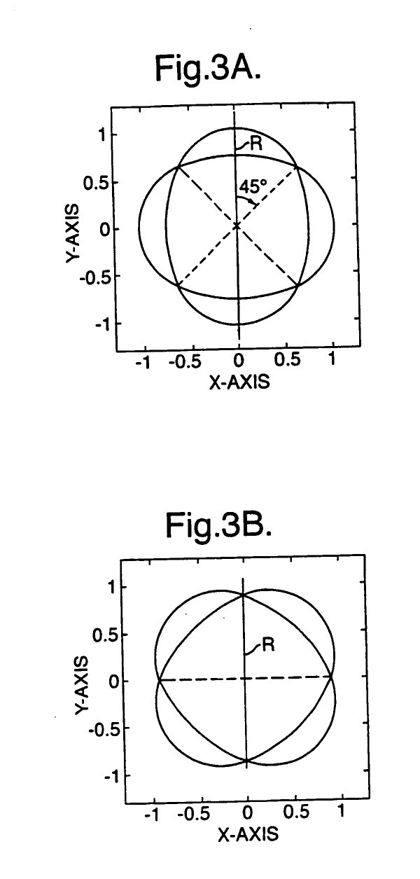

The use of ring shaped resonators in single axis Coriolis rate sensors is well known. Examples of such devices are described in EP 0581407 A1 (Norris—Metal ring), GB 9703357.5 (Inductive gyro), GB 9817347.9 (Capacitive gyro) and U.S. Pat. No. 5,450,751 (Delco ring device). These devices make use of the degenerate Cos 2θ and Sin 2θ modes, shown in FIGS. 3A and 3B which exist at a mutual angle of 45°. In operation, one of these modes, FIG. 3A is excited as the carrier vibration mode. Rotation applied about the axis normal to the plane of the ring will induce Coriolis forces which couple energy into the response mode, FIG. 3B. the amplitude of motion of the response mode is directly proportional to the applied rate.

In all of the example known devices the carrier and response mode frequencies are required to be nominally identical. The leg structures supporting these ring structures have the effect of individual spring masses acting at the point of attachment to the ring. As such, they will locally alter the mass and stiffness hence shifting the mode frequencies. The number and location of these supports must be such that the dynamics of the carrier and response modes are not differentially perturbed. Thus, while both mode frequencies will be shifted, they will be changed by an equal amount and no frequency split will be introduced. The number of support legs required to achieve this is equal to 4 n, where n is the number of nodal diameters (n=2 for Cos 2θ modes) and k is an integer, with the angular separation given by 90°/n. In all of these devices this is achieved by the use of eight equi-angularly spaced support legs.

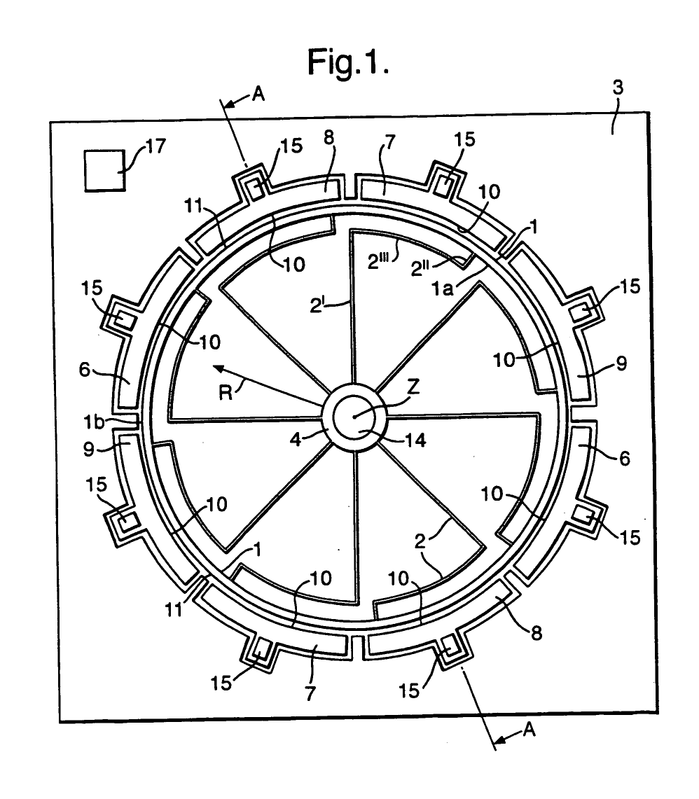

These leg structures are required to suspend the ring but must also allow it to vibrate in an essentially undamped oscillation. FIG. 1 shows a device of this type, as described in GB 9817347.9, having a substantially planar vibratory resonator 1 with a substantially ring or hoop-like structure with inner and outer peripheries 1a and 1b, respectively, extending around a common axis 7. Eight flexible support legs 9 are provided for supporting the resonator 1 and for allowing it to vibrate in response to drive means in a substantially undamped oscillation mode, such as to permit the resonator 1 to move relative to a rigidly fixed central support boss 4 in response to turning rate. Each support leg 2 comprises a first linear part 2¹ extending from the central boss 10 towards the resonator 5 and a second linear part 2¹¹ extending from the inner periphery 6 of the resonator 5 towards the common axis 8 but radially displaced from the first leg part 2¹. The first and second leg parts 2¹ and 2¹¹ are connected by an arcuate leg part 2¹¹¹ concentric with the vibratory resonator 1. The three leg parts will be integrally formed.

For devices such as these, the radial and tangential stiffness of the legs should be significantly lower than that of the ring itself so that the modal vibration is dominated by the ring structure. The radial stiffness is largely determined by the length of the arcuate segment 2¹¹¹ of the leg. The straight segments 2¹ and 2¹¹ of the leg dominate the tangential stiffness. Maintaining the ring to leg compliance ratio, particularly for the radial stiffness, for this design of leg becomes increasingly difficult as the arc angle of the leg structure is restricted by the proximity of the adjacent legs. This requirement places onerous restrictions on the mechanical design of the support legs and necessitates the use of leg structures which are thin (in the plane of the ring) in comparison to the ring rim. This reduced dimension renders these structures more susceptible to the effects of dimensional tolerancing in the production processes of the mechanical structure. This will result in variation in the mass and stiffness of these supporting leg elements which will disturb the symmetry of the mode dynamics and hence induce frequency splitting between Cos 2θ vibration mode pair.

The structures described in the prior art may be fabricated in a variety of materials using a number of processes. Where such devices are fabricated from metal these may be conveniently machined to high precision using wire erosion techniques to achieve the accurate dimensional tolerancing required. This process involves sequentially machining away material around the edges of each leg and the ring structure. The machining time, and hence production cost, increases in proportion to the number of legs. Minimising the number of legs is therefore highly beneficial. Similar considerations apply to structures fabricated from other materials using alternative processes.

It would be desirable to be able to design planar ring structures which require a reduced number of support legs but without affecting the vibration of the ring structure to any greater extent from the prior art arrangements having a relatively large number of support legs.

According to a first aspect of the present invention, there is provided a single axis rate sensor including a substantially planar vibratory resonator having a substantially ring or hoop-like structure with inner and outer peripheries extending around a common axis, drive means for causing the resonator to vibrate in a Cos 2θ vibration mode, carrier mode pick-off means for sensing movement of the resonator in response to said drive means, pick-off means for detecting Sin 2θ vibration mode motion induced by rotation around the Z axis, Sin 2θ vibration mode drive means for nulling said motion and support means for flexibly supporting the resonator and for allowing the resonator to vibrate relative to the support means in response to the drive means or to applied rotation, wherein the support means comprises only L support beams, where L≠2^{K} and K=0, 1, 2 or 3. For example, there may be three, five six or seven support beams.

Preferably, there are fewer than eight support beams, as this simplifies the manufacturing process.

Each support beam may comprise first and second linear portions extending from opposite ends of an arcuate portion.

In the embodiment, the support beams are substantially equi-angularly spaced.

Conveniently, the support means includes a base having a projecting boss, with the inner periphery of the substantially ring or hoop-like structure being coupled to the boss by the support beams which extend from the inner periphery of the ring or hoop-like structure to the projecting boss.

In the embodiment, the total stiffness of the support beams is less than that of the ring or hoop-like structure.

The formulae defined above have been obtained as a result of a detailed analysis of the dynamics of the ring or hoop-like structure including the effects of leg motion. The present invention may provide increased design flexibility allowing greater leg compliance (relative to the ring) whilst employing increased leg dimensions (in the plane of the ring). Such designs may exhibit reduced sensitivity to dimensional tolerancing effects and allow more economical fabrication.

For a better understanding of the present invention, and to show how the same may be carried into effect, reference will now be made, by way of example, to the accompanying drawings, in which:

FIG. 1 is a plan view of a vibrating structure gyroscope having eight support legs not according to the present invention;

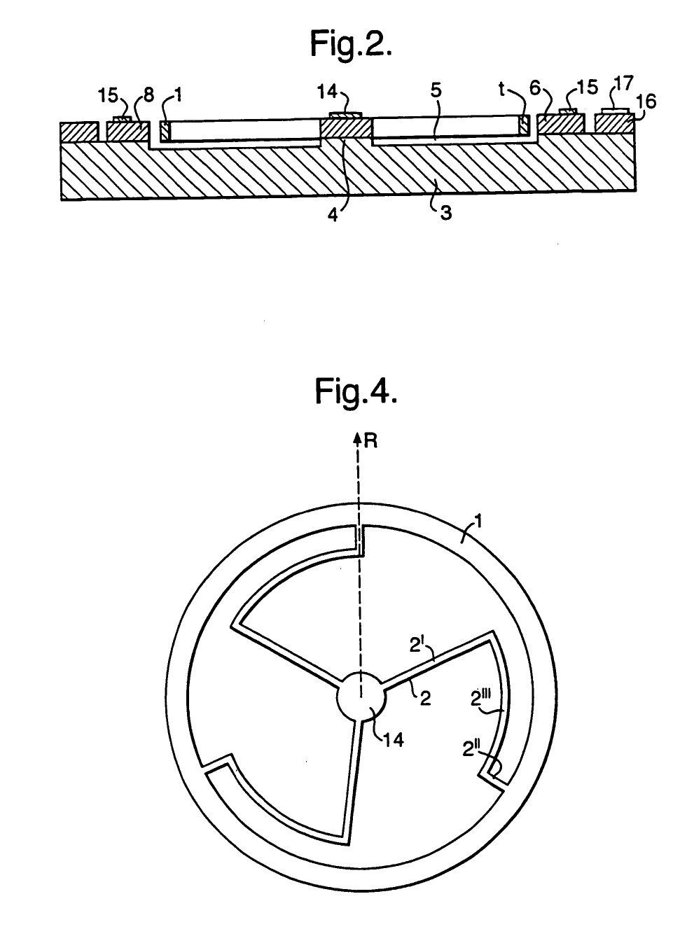

FIG. 2 is an edge view of a detail of the gyroscope of FIG. 1;

FIG. 3A shows diagrammatically a Cos 2θ mode vibration is a symmetric resonator or vibrating structure acting as a carrier mode;

FIG. 3B is a diagrammatic illustration of a Sin 2θ mode at 45° to that of FIG. 3A but acting as a response mode; and

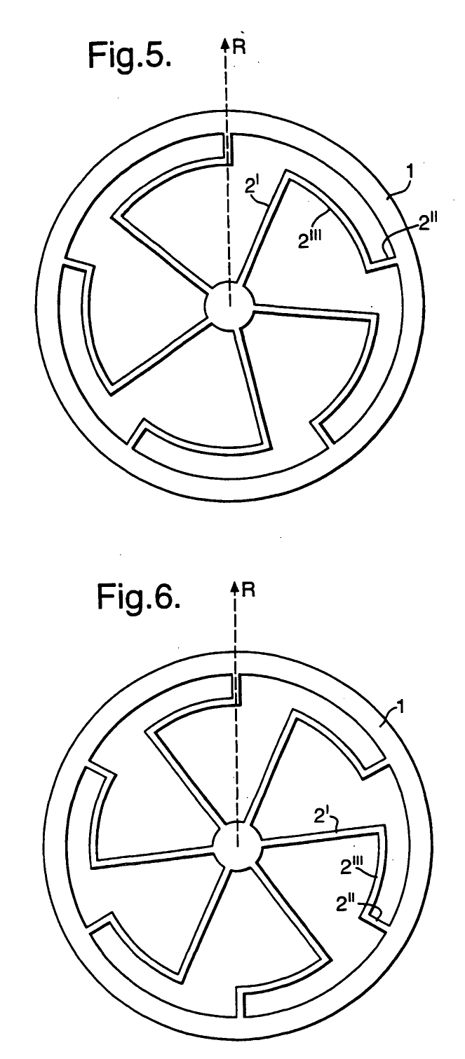

FIGS. 4, 5 and 6 are plan views of a vibrating structure gyroscope having three, five and six support legs, respectively according to the present invention.

An angular rate sensor according to the prior art as shown in FIGS. 1 and 2, suitable for use as a vibrating structure gyroscope, includes a substantially planar vibrating resonator 1 having a substantially ring or hoop-like shape structure with an inner periphery 1a and an outer periphery 1b. The inner and outer peripheries 1a and 1b extend around a common axis Z as shown in FIG. 2 of the accompanying drawings. The sensor also includes support means which in turn include a plurality of flexible support beams 2 for supporting the resonator 1 and for allowing the resonator 1 to vibrate, when driven, in a substantially undamped oscillation mode such as to permit the resonator 1 to move relative to the support means in response to turning rate. The support means also includes a base 3 made from electrically insulating material and having a projecting boss 4. The base 3 which is made from electrically insulating material has means for electrically grounding it. The inner periphery 1a of the resonator 1 is coupled to the boss 4 by the support beams 2 which extend from the inner periphery 1a to the boss 4 so that the ring or hoop-like shape resonator structure is spaced from the boss 4 as can be seen in FIG. 2. The total stiffness of the support beams 2 is less than that of the ring-like resonator 1. In this manner a cavity 5 is provided in the region directly under the ring-like resonator 1 and support beams 2 to that they are freely suspended from the boss 4. In the prior art sensor illustrated in FIGS. 1 and 2 of the accompanying drawings, there are eight equi-angularly spaced support beams 2.

The resonator structure is excited into resonance at the Cos 2θ mode (see FIG. 3A) frequency by means of electrostatic drive means with the resultant motion detected using electrostatic pick-off means.

The support beams 2 and resonator 1 are made from crystalline silicon and the sensor also includes electrostatic drive means for causing the resonator 1 to vibrate and electrostatic sensing means for sensing movement of the resonator 1. The electrostatic drive means and electrostatic sensing means include plate-like elements 6, 7, 8 and 9 made from crystalline silicon in the form of transducers having surfaces 10 located substantially normal to the plane of the resonator 1 at a spacing 11 from the adjacent outer periphery 1b of the resonator 1.

The electrostatic drive means includes two electrostatic carrier mode plate-like drive elements 6 for causing the resonator 1 to vibrate in a Cos 2θ carrier mode, which carrier mode drive elements 6 are located at 0° and 180° with respect to a fixed reference axis R located in the plane of the resonator 1. The reference axis R is taken from the geometric centre of the resonator 1 to the centre point of the one of the carrier mode drive elements 6. The electrostatic drive means also includes two electrostatic response mode plate-like drive elements 8 located at 45° and 225° with respect to the reference axis R.

The electrostatic sensing means includes two electrostatic carrier mode plate-like pick-off elements 7 located at 90° and 270° with respect to the reference axis R and two response mode plate-like pick-off elements 9 for sensing motion of the resonator 1 in response to rotation of the sensor about an axis normal to the plane of the resonator 1, namely the axis Z, which response mode pick-off elements 9 and located at 135° and 315° with respect to the reference axis R.

When the sensor is rotated about the Z axis, Coriolis forces will couple energy into the response mode with an amplitude of motion directly proportional to the applied rate. This motion is detected by the pick-off elements 9. The rate induced motion may be nulled by means of the response mode drive elements 8 to enable the sensor to be operated in a closed loop configuration which is known to give performance advantages. In this mode of operation the nulling force is directly proportional to the applied rate.

As aforesaid the drive and pick-off transducers are identical plate-like elements formed from the crystalline silicon. The plate surface 10 normal to the plane of the resonator 1 forms a capacitor with the facing surface of the adjacent segment of the resonator 1. The plate subtends an angle of 40° with a 5° angular spacing between adjacent transducer elements. The capacitor spacing 11 is maintained at a constant value across the area of the capacitor plates. The transducer sites and central boss 4 of the resonator 1 are rigidly fixed to the supporting base 3 which comprises an electrically insulating material such as glass.

The resonator structure is maintained at a fixed DC bias voltage with respect to the drive and pick-off elements. The electrical connection from the control circuitry is made, by means of a bond wire (not shown), onto a metal bond pad 14 deposited onto the surface of the resonator structure at the central boss 4. Bond pads 15 are similarly deposited on the upper surface of the drive and pick-off elements.

A detailed analysis of the dynamics of the ring including the effects of the leg motion has enabled simple formulae to be developed which prescribe the range of options available in terms of the number of substantially evenly spaced support legs required to maintain frequency matching of the desired vibration mode pairs.

The analysis indicates that the requirement on the number of legs is far less restrictive than previously indicated. Simple formulae have been derived indicating which modes will have their frequency split for a given number of evenly spaced support legs. These formulae are generally applicable to both in plane and out of plane Cos Nθ modes where N is the mode order and are valid for L>2. If ≦2 then all modes will be split. For an even number of legs, L, frequency splitting for a mode of order N will only occur when the following condition is met:

$$N = \frac{LK}{2}$$

where K is an integer. Maximum frequency splitting occurs when K=1 and reduces as K is increased. If the number of legs, L, is odd then frequency splitting will only occur where:

N=LK

The maximum splitting again occurs for K=1 and decreases as the value of K increases.

Applying these general principles to the single axis planar ring resonator designs of the prior art, employing Cos 2θ modes, leads to the conclusion that the number of support legs is no longer restricted to eight. Planar ring resonators with support leg structures conforming to the following formula, may be constructed:

L≠N^{K}

where N is the mode order (=2 for Cos 2θ modes) and K is an integer of value 0, 1, 2 or 3. The legs should be equi-angularly spaced.

Support structures consisting of three legs at 120° spacing, five legs at 72° spacing, six legs at 60° spacing, seven legs at 51.4° spacing, etc., such as shown in FIGS. 4, 5 and 6 which preserve the required mode frequency matching and are suitable for use in Coriolis rate sensors, may therefore be utilised. Although providing eight or more legs may preserve mode frequency matching, providing more than seven legs is disadvantageous for the reasons discussed above.

In all resonator designs the combined stiffness of the support legs is required to be less than that of the ring. This ensures that the modal vibration is dominated by the ring structure and helps to isolate the resonator from the effects of thermally induced stresses coupling in via the hub 20 of the structure, which will adversely affect performance. Then employing fewer support legs the required leg to ring compliance ratio may be maintained by using longer support leg structures of increased width. This renders these structures less susceptible to the effects of dimensional tolerancing errors arising during the fabrication process. Such errors induce frequency splitting between the Sin 2θ and Cos 2θ modes, which are detrimental to the sensor performance. These typically necessitate the use of mechanical trimming procedures to achieve the desired performance levels. Reducing the requirement for this trimming procedure is therefore highly desirable in terms of cost and fabrication time.

1. A single axis rate sensor including a substantially planar vibratory resonator having a substantially ring or hoop-like structure with inner and outer peripheries extending around a common axis, drive means for causing the resonator to vibrate in a Cos 2θ vibration mode, carrier mode pick-off means for sensing movement of the resonator in response to said drive means pick-off means for detecting Sin 2θ vibration mode motion induced by rotation around the z-axis, Sin 2θ vibration mode drive means for nulling said motion, and support means for flexibly supporting the resonator and for allowing the resonator to vibrate relative to the support means in response to the drive means, or to applied rotation wherein the support means comprises only L support beams, where L≠2^{K} and K=0, 1, 2or 3.

2. A rate sensor according to claim 1 wherein L<8.

3. A rate sensor according to claim 1 or claim 2, wherein each support beam comprises first and second linear portions extending from opposite ends of an arcuate portion.

4. A rate sensor according to any one of the preceding claims, wherein the support beams are substantially equi-angularly spaced.

5. A rate sensor according to any one of the preceding claims, wherein the support means includes a base having a projecting boss, with the inner periphery of the substantially ring or hoop-like structure being coupled to the boss by the support beams which extend from said inner periphery of the ring or hoop-like structure to the projecting boss.

6. A rate sensor according to any one of the preceding claims wherein the total stiffness of the support beams is less than that of the ring or hoop-like structure.

7. A rate sensor substantially as hereinbefore described with reference to and/or substantially as illustrated in FIGS. 4, 5 or 6 of the accompanying drawings.
